(19) United States
(12) Patent Application Publication
(10) Pub. No.: US 2025/0037445 A1
(43) Pub. Date: Jan. 30, 2025

(54) METHOD FOR FUSING IMAGE DATA IN THE CONTEXT OF AN ARTIFICIAL NEURAL NETWORK

(71) Applicant: Continental Autonomous Mobility Germany GmbH, Ingolstadt (DE)

(72) Inventors: Tobias Bund, Ehingen (DE); Mario Rometsch, Blaustein (DE); Robert Thiel, Sigmarszell (DE)

(73) Assignee: Continental Autonomous Mobility Germany GmbH, Ingolstadt (DE)

(21) Appl. No.: 18/716,043

(22) PCT Filed: Nov. 10, 2022
(86) PCT No.: PCT/DE2022/200262

§ 371 Date: Jun. 3, 2024

(30) Foreign Application Priority Data
Dec. 3, 2021 (DE) 10 2021 213 757.1

(51) Int. Cl. G06V 10/80; B60W 60/00; G01C 21/36; G06V 10/12; G06V 10/77; G06V 10/82; G06V 20/56

(52) U.S. Cl. CPC G06V 10/806; G01C 21/3602; G06V 10/12; G06V 10/7715; G06V 10/82; G06V 20/56; B60W 60/00; B60W 2420/403; B60W 2556/35; B60W 2556/40

(57) ABSTRACT

A method and system for fusing image data from an image acquisition sensor. The method includes: a) receiving input image data including: a first image which having a first region of a scene, and a second image which includes a second region of the scene, wherein the first and second regions overlap one another but are not identical; b) determining first and second feature maps using the first and second images, respectively; c) computing first and second output feature maps by convolutions of the first and second feature maps, respectively; d) computing a fused feature map through element-by-element addition of the first and second output feature maps, wherein the relative positions of the first and second regions are utilized, such that elements in the region of overlap are added. The method is runtime-efficient and fuses image data from one or more image acquisition sensors for an ADAS/AD vehicle system.

### CROSS-REFERENCE TO RELATED APPLICATIONS

The present application is a National Stage Application under 35 U.S.C. § 371 of International Patent Application No. PCT/DE2022/200262 filed on Nov. 10, 2022, and claims priority from German Patent Application No. 10 2021 213 757.1 filed on Dec. 3, 2021, in the German Patent and Trademark Office, the disclosures of which are herein incorporated by reference in their entireties.

### TECHNICAL FIELD

The invention relates to a method and to a system for fusing image data, for example in an environment sensor-based ADAS/AD system for a vehicle in the context of an artificial neural network.

### BACKGROUND

In the case of imaging environment sensors for ADAS/AD systems (in particular, camera sensors), the resolution is constantly being increased, making it possible to recognize smaller objects and to recognize sub-objects and, e.g., to read small text at a great distance. One disadvantage of the higher resolution is the significantly higher computing power which is required to process the correspondingly large image data. Thus, various resolution levels of image data are frequently utilized for the processing. Large ranges or high resolutions are, e.g., frequently required in the center of the image, but not at the edge region (similar to the human eye).

DE 102015208889 A1 discloses a camera device for imaging an environment for a motor vehicle having an image sensor apparatus for capturing a pixel image, and a processor apparatus which is designed to combine neighboring pixels of the pixel image in an adjusted pixel image. Different adjusted pixel images can be produced in different resolutions by combining the pixel values of the neighboring pixels in the form of a 2×2 image pyramid or a n×n image pyramid.

U.S. Pat. No. 10,742,907 B2 and U.S. Pat. No. 10,757,330 B2 disclose driver assistance systems having capturing of images with variable resolutions.

U.S. Pat. No. 10,798,319 B2 describes a camera device for acquiring images of a surrounding region of an ego vehicle with a wide-angle optical system and a high-resolution image acquisition sensor. A resolution-reduced image of the entire acquisition region generated by means of pixel binning, or a partial region of the acquisition range with maximum resolution can be acquired for one image of the sequence of images.

Technologies which deploy artificial neural networks are more and more frequently being used in environment sensor-based ADAS/AD systems in order to be able to better recognize, classify and at least partially understand the road users and the scene. Deep neural networks such as, e.g., a CNN (convolutional neural network) have clear advantages with respect to classic methods. Classic methods tend to use handmade features (histogram of oriented gradients, local binary patterns, Gabor filter, etc.) with taught classifiers such as support vector machines or AdaBoost. In the case of (multi-level) CNNs, the feature extraction is attained algorithmically through machine (deep) learning and, as a result, the dimensionality and depth of the feature space is significantly increased, which ultimately leads to a significantly better performance, e.g., in the form of an increased recognition rate.

Processing, in particular when merging sensor data having a different, also overlapping, acquisition range and a different resolution, constitutes a particular challenge.

EP 3686798 A1 discloses a method for learning parameters of an object detector based on a CNN. In a camera image, object regions are estimated and sections of these regions are generated from different image pyramid levels. The sections have, e.g., an identical height and are laterally padded and concatenated by means of “zero padding”. This form of concatenation can be casually described as an art collage: the sections of identical height are “glued next to one another”. The produced synthetic image is consequently composed of different resolution levels of regions of the same original camera image. The CNN is trained in that the object detector detects objects on the basis of the synthetic image and is, as a result, in a position to also detect objects further away.

An advantage of such a procedure with respect to separate processing of the individual image regions by means of a CNN one after the other is that the weights for the synthetic image only have to be loaded once.

The disadvantage in this case is that the image regions in the synthetic image are viewed next to one another and in particular independently of one another by the CNN with the object detector. Objects located in the region of overlap, which are possibly incompletely contained in an image region, have to be identified in a non-trivial manner as belonging to one and the same object.

### SUMMARY

It is an aspect of the present disclosure to provide an improved image data fusion method in the context of an artificial neural network, which efficiently fuses input image data from different, partially overlapping acquisition ranges and provides these for subsequent processing.

An aspect of the present disclosure relates to an efficient implementation of object recognition on input data from at least one image acquisition sensor, which
a) acquires a large image region, and
b) acquires relevant image reports such as, for example, distant objects in the center of the image, in high resolution.

The following considerations are prioritized during the development of the solution.

In order to use multiple levels of an image pyramid in a neural network, a lower-resolution overview image and a higher-resolution central image section could be processed separately by two independent inferences (two CNNs which are trained for this).

This means a large computing/runtime outlay. Inter alia, weights of the trained CNNs have to be reloaded for the different images. Features of various pyramid levels are not considered in a combined manner.

Alternatively, the processing could be carried out in a similar way to EP 3686798 A1 for an image composed of various resolution levels. That is to say a composite image would be produced from various partial images/resolution levels and an inference or a trained CNN would run thereover. This can be rather more efficient since each weight is only loaded once for all of the images and not reloaded for each partial image. However, the remaining disadvantages such as the lack of a combination of features of different resolution levels remain.

The method for fusing image data from at least one image acquisition sensor includes the following steps:
a) receiving input image data, wherein the input image data include:
   a first image (or a first representation) which includes or contains a first region of a scene, and
   a second image which includes or contains a second region of the scene, wherein the first and second regions overlap one another but are not identical;
b) determining a first feature map with a first height and width on the basis of the first image and determining a second feature map with a second height and width on the basis of the second image,
c) computing a first output feature map by means of a first convolution of the first feature map, and computing a second output feature map by means of a second convolution of the second feature map;
d) computing a fused feature map through element-by-element addition of the first and second output feature maps, wherein the position of the first and the second region with respect to one another is taken into consideration, such that the elements (of the first and second output feature maps) in the region of overlap are added; and
e) outputting the fused feature map.

An image can, for example, be a two-dimensional representation of a scene which is acquired by an image acquisition sensor.

A point cloud or a depth map are examples of three-dimensional images or representations which, e.g., a lidar sensor or a stereo camera can acquire as an image acquisition sensor. A three-dimensional representation can be converted into a two-dimensional image for many purposes, e.g., by a planar section or a projection.

A feature map can be determined by a convolution or a convolutional layer/convolution kernel from an image or another (already existing) feature map.

The height and width of a feature map are related to the height and width of the underlying image (or the incoming feature map) and the operation.

The position of the first and the second region with respect to one another is in particular taken into consideration in order to add the appropriate elements of the first and second output feature maps for the fusion. The position of the region of overlap can be defined by starting values (xₛ, yₛ) which indicate, for example, the position of the second output feature map in the vertical and horizontal directions within the fused feature map. In the region of overlap, the elements of the first and second output feature maps are added. Outside of the region of overlap, the elements of the output feature map can be transferred to the fused feature map which covers the region. If neither of the two output feature maps covers a region of the fused feature map, this can be zero padded.

The method is performed, e.g., in the context of an artificial neural network, such as a convolutional neural network (CNN).

For ADAS/AD functionalities, at least one artificial neural network or CNN is frequently deployed (especially on the perception side) which is trained by means of a machine learning method to assign image input data to relevant output data for the ADAS/AD functionality. ADAS stands for Advanced Driver Assistance Systems and AD stands for Automated Driving. The trained artificial neural network can be implemented on a processor of an ADAS/AD controller in a vehicle. The processor can be configured to evaluate image data using the trained artificial neural network (inference). The processor can include a hardware accelerator for the artificial neural network.

The processor or the inference can be configured, for example, in order to detect or determine in more detail ADAS/AD-relevant information from input image data from one or more image acquisition sensors. Relevant information is, e.g., objects and/or surrounding information for an ADAS/AD system or an ADAS/AD controller. ADAS/AD-relevant objects and/or surrounding information are, e.g., things, markings, road signs, road users as well as distances, relative speeds of objects etc., which represent important input variables for ADAS/AD systems. Examples of functions for detecting relevant information are lane recognition, object recognition, depth recognition (3D estimation of the image components), semantic recognition, road sign recognition and so forth.

In one embodiment, the first and the second image have been acquired by the same image acquisition sensor. This can also be an upstream step of the method. In particular, the first and the second image can have been acquired simultaneously by the image acquisition sensor or immediately one after the other.

In one embodiment, the (single) image acquisition sensor is a monocular camera. The first representation (or the first image) can correspond to a wide-angled acquired overview image having reduced resolution and the second representation (or the second image) can correspond to a partial image having higher resolution.

According to one exemplary embodiment, the first and second images correspond to different image pyramid levels of an (original) image acquired by an image acquisition sensor.

The input image data can be encoded in multiple channels depending on the resolution. For example, each channel has the same height and width. The spatial relationship of the contained pixels can be maintained within each channel. For details regarding this, reference is made to DE 102020204840 A1, the entire contents of which are included in this application.

In one embodiment, the first region is an overview region of the scene and the second region is a partial region of the overview region of the scene. The overview region, which is contained in the first image, can correspond to a total region, that is to say a maximum acquisition range of the image acquisition sensor.

The partial region of the scene, which is contained in the second image, can correspond to a region of interest (ROI) which is also contained in the first image.

According to one exemplary embodiment, the first image has a first resolution and the second image has a second resolution. The second resolution is, for example, higher than the first resolution. The resolution of the second image can correspond to the maximum resolution of an image acquisition sensor. For example, the higher resolution can provide more details regarding the partial region or the ROI which is the content of the second image.

The resolution of an image can correspond to an accuracy or a data depth, e.g., a minimum distance between two neighboring pixels of an image acquisition sensor.

In one embodiment, two monocular cameras having an overlapping acquisition range are deployed as image acquisition sensors. The two monocular cameras can be a constituent part of a stereo camera. The two monocular cameras can have different aperture angles and/or resolutions (“hybrid stereo camera”). The two monocular cameras can be satellite cameras which are fastened independently of one another to the vehicle.

According to one exemplary embodiment, multiple cameras of a panoramic-view camera system are deployed as image acquisition sensors. For example, four monocular cameras with a fisheye optical system (acquisition angle of, e.g., 180° or more) can acquire images of the complete surroundings of a vehicle. Every two neighboring cameras have a region of overlap of approx. 90°. Here, it is possible to create a fused feature map for the 360° surroundings of the vehicle from the four individual images (four representations).

In one embodiment, the first and the second output feature maps have the same height and width in the region of overlap. In other words, neighboring elements in the region of overlap of the output feature maps are equidistant from each other in real space. This can therefore be the case since the first and second feature maps already have the same height and width in the region of overlap. For example, the first and second regions or the first and second images (also) have the same height and width in the region of overlap.

According to one exemplary embodiment, the height and width of the fused feature map are determined by the rectangle which surrounds (exactly encloses) the first and the second output feature map.

In one embodiment, after the height and width of the fused feature map have been determined by the rectangle which surrounds (exactly encloses) the first and the second output feature map, the first and/or second output feature map can be enlarged or adapted such that they obtain the width and height of the fused feature map, and the position of the first and second output feature map with respect to one another is retained. The region of overlap is in the same position in the case of both adapted output feature maps. The newly added areas of the respective (adapted) output feature map due to the enlargement are padded with zeros (zero padding). The two adapted output feature maps can be subsequently added element-by-element.

According to one exemplary embodiment, a template output feature map is initially created, the width and height of which result from the height and width of the first and second output feature maps and the position of the region of overlap (cf. last paragraph, surrounding rectangle). The template output feature map is padded with zeroes.

For the adapted first output feature map, the elements from the first output feature map are adopted in the region covered by the first output feature map. To this end, starting values can be used, which indicate the position of the first output feature map in the vertical and horizontal directions within the template output feature map. The adapted second output feature map is formed in a corresponding manner. The two adapted output feature maps can, in turn, be subsequently added element-by-element.

In one embodiment, in the special case that the second output feature map contains the entire region of overlap (that is to say, a genuine partial region of the first output feature map which includes an overview region), an adaption of the different height and width of the second output feature map can be dispensed with. In this case, the first output feature map does not have to be adapted either, since the fused feature map will have the same height and width as the first output feature map. In this case, the element-by-element addition of the second output feature map to the first output feature map can only be performed in the region of overlap by means of suitable starting values. Within the first output feature map, the starting values specify from where (namely in the region of overlap) the elements of the second output feature map are added to the elements of the first output feature map in order to generate the fused feature map.

In one embodiment, the feature maps have a depth which depends on the resolution of the (underlying) images. A higher-resolution image (e.g., image section) results in a feature map having greater depth, e.g., the feature map contains more channels.

For example, a processor can include a hardware accelerator for the artificial neural network, which can further process a stack of multiple image channel data “packets” during a clock cycle or computing cycle. The image data or feature (map) layers can be fed to the hardware accelerator as stacked image channel data packets.

According to one exemplary embodiment, ADAS/AD-relevant features are detected on the basis of the fused feature map.

In one embodiment, the method is implemented in a hardware accelerator for an artificial neural network or CNN.

According to one exemplary embodiment, the fused feature map is generated in an encoder of an artificial neural network or CNN which is set up or trained to determine ADAS/AD-relevant information.

In one embodiment, the artificial neural network or CNN, which is set up or trained to determine ADAS/AD-relevant information, includes multiple decoders for different ADAS/AD detection functions.

A further aspect of the present disclosure relates to a system or to a device for fusing image data from at least one image acquisition sensor. The device includes an input interface, a data processing unit and an output interface.

The input interface is configured to receive input image data. The input image data include a first and a second image. The first image includes or contains a first region of a scene.

The second image contains a second region of the scene. The first and the second regions overlap one another. The first and second regions are not identical.

The data processing unit is configured to perform the following steps b) to d):
b) determining a first feature map with a first height and width on the basis of the first image and determining a second feature map with a second height and width on the basis of the second image;
c) computing a first output feature map by means of a first convolution of the first feature map, and computing a second output feature map by means of a second convolution of the second feature map;
d) computing a fused feature map through element-by-element addition of the first and second output feature maps. The position of the first and the second region with respect to one another is taken into consideration during the element-by-element addition, such that the elements (of the first and second output feature maps) in the region of overlap are added.

The output interface is configured to output the fused feature map.

The fused feature map can be output to a downstream ADAS/AD system or to downstream layers of a “large” ADAS/AD CNN or further artificial neural networks.

According to one exemplary embodiment, the system includes a CNN hardware accelerator. The input interface, the data processing unit and the output interface are implemented in the CNN hardware accelerator.

In one embodiment, the system includes a convolutional neural network having an encoder. The input interface, the data processing unit and the output interface are implemented in the encoder such that the encoder is configured to generate the fused feature map.

According to one exemplary embodiment, the convolutional neural network includes multiple decoders. The decoders are configured to realize different ADAS/AD detection functions at least on the basis of the fused feature map. That is to say that multiple decoders of the CNN can utilize the input image data encoded by a common encoder. Different ADAS/AD detection functions are, for example, semantic segmentation of the images or image data, free space recognition, lane detection, object detection or object classification.

In one embodiment, the system includes an ADAS/AD controller, wherein the ADAS/AD controller is configured to realize ADAS/AD functions at least on the basis of the results of the ADAS/AD detection functions.

The system can include the at least one image acquisition sensor. For example, a monocular camera, in particular having a wide-angled acquisition range (e.g., at least) 100° and a high maximum resolution (e.g., at least 5 megapixels), a stereo camera, satellite cameras, individual cameras of a panoramic-view system, lidar sensors, laser scanners or other 3D cameras serve as (the) image acquisition sensor(s).

A further aspect of the present disclosure relates to a vehicle having at least one image acquisition sensor and a corresponding system for fusing the image data.

The system or the data processing unit can, in particular, include a microcontroller or processor, a central processing unit (CPU), a graphics processing unit (GPU), a tensor processing unit (TPU), a neural/AI processing unit (NPU), a digital signal processor (DSP), an ASIC (Application Specific Integrated Circuit), a field-programmable gate array (FPGA) and so forth as well as software for performing the corresponding method steps.

According to one embodiment, the system or the data processing unit is implemented in a hardware-based image data preprocessing stage (e.g., an image signal processor (ISP)).

Furthermore, the present disclosure relates to a computer program element or program product which, when a processor of a system for image data fusion is programmed therewith, instructs the processor to perform a corresponding method for fusing input image data.

Furthermore, the present disclosure relates to a computer-readable storage medium on which such a program element is stored.

The present disclosure can consequently be implemented in digital electronic circuits, computer hardware, firmware or software.

### BRIEF DESCRIPTION OF THE DRAWINGS

Exemplary embodiments and figures are described below in the context of the present disclosure, wherein:

FIG. 1 shows a system for fusing image data from at least one image acquisition sensor;

FIG. 2 shows the extent and position of a first and second acquisition range of an image acquisition sensor or of two different image acquisition sensors, from which a first and second image of a scene can be established;

FIG. 3 shows a high-resolution overall image;

FIG. 4 shows the reduced-resolution overall image or overview image;

FIG. 5 shows a high-resolution central image section;

FIG. 6 shows an alternative arrangement of a first (overall) acquisition range and of a second central acquisition range;

FIG. 7 shows an example of how corresponding digital images appear as a grayscale image;

FIG. 8 shows a way in which such images can in principle be fused;

FIG. 9 shows an alternative second way to obtain fusion;

FIG. 10 shows an advantageous third way to obtain fusion;

FIG. 11 shows a concatenation of two feature maps which are subsequently processed (and, as a request, fused) by a convolution kernel;

FIG. 12 shows an alternative process in which two feature maps are processed by two separate convolution kernels and, subsequently, an element-by-element addition is carried out;

FIG. 13 shows a process for fusing two feature maps of different width and height; and

FIG. 14 shows a possible course of the method.

### DETAILED DESCRIPTION

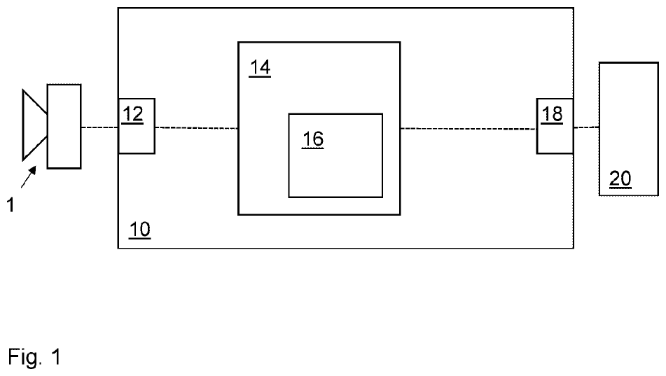

FIG. 1 schematically shows a system 10 for fusing data from at least one sensor 1 having an input interface 12, a data processing unit 14 with a fusion module 16 and an output interface 18 for outputting fused data to a further unit 20.

An example of an image acquisition sensor 1 is a monocular camera sensor having a wide-angle optical system and a high-resolution image acquisition sensor, e.g., a CCD or CMOS sensor.

The resolution and/or acquisition ranges of the image data or the image acquisition sensors frequently differ(s). Image data preprocessing is useful for a fusion, which makes possible the fusion of features from the image data from the image detection sensor(s).

One exemplary embodiment, which is discussed in more detail below, features the processing of a first image from a camera sensor and a second image from the same camera sensor, wherein the second image (only) has a partial region of the first image and a higher resolution, compared to the resolution of the first image.

Based on the image data from the camera sensor, multiple ADAS or AD functions can be provided by an ADAS/AD controller, as an example for the further unit 20, e.g., lane recognition, lane keeping driving assistance, road sign recognition, speed limit assistance, road user recognition, collision warning, emergency braking assistance, adaptive cruise control, construction site assistance, a highway pilot, a Cruising Chauffeur function and/or an autopilot.

The overall system 10, 20 can include an artificial neural network, for example a CNN. To allow the artificial neural network to process the image data in real time, for example, in a vehicle, the overall system 10, 20 can include a hardware accelerator for the artificial neural network. Such hardware modules can accelerate the substantially software-implemented neural network in a dedicated manner such that real-time operation of the neural network is possible.

The data processing unit 14 can process the image data in a “stacked” format, that is to say, it is in a position to read in and to process a stack of multiple input channels within one computing cycle (clock cycle). In a specific example, it is possible for a data processing unit 14 to read in four image channels of a resolution of 576×320 pixels. A fusion of at least two image channels would offer the advantage for subsequent CNN detection that the channels do not have to be processed individually by corresponding CNNs, but rather channel information or feature maps which have already been fused can be processed by one CNN. Such a fusion can be carried out by a fusion module 16. The details of the fusion are explained more fully below on the basis of the following figures.

The fusion can be implemented in the encoder of the CNN. The fused data can be subsequently processed by one or more decoders of the CNN, from which detections or other ADAS/AD-relevant information can be obtained. In the case of such a division, the encoder in FIG. 1 would be represented by the block 10, the decoder(s) would be represented by the block 20. The CNN would include blocks 10 and 20, hence the designation “overall system”.

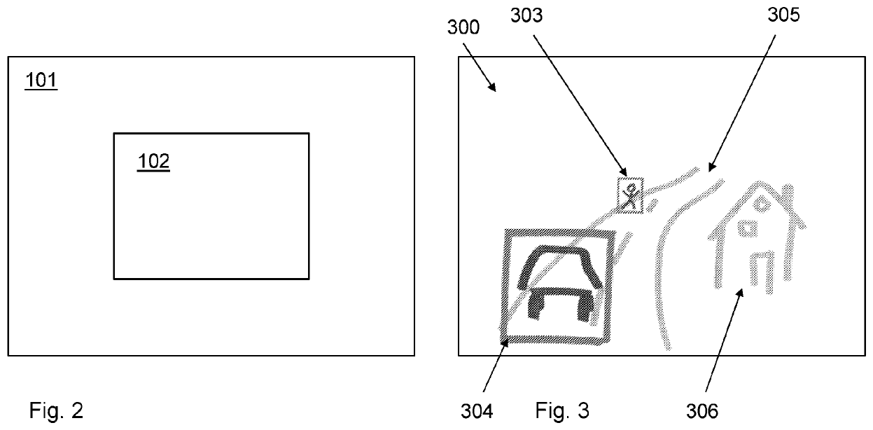

FIG. 2 schematically shows the extent and position of a first acquisition range 101 and a second 102 acquisition range of an image acquisition sensor 1 or of two different image acquisition sensors, from which a first and second image of a scene can be established. An overview or overall view can be acquired as a first image from the first image acquisition range 101 and a second image, which contains a detail of the first image acquisition range 101, can be acquired from a second image acquisition range 102, e.g., a central image region. FIGS. 3 to 5 show examples of which images can be acquired with an image acquisition (or camera) sensor.

FIG. 3 schematically shows a high-resolution overview image or overall image 300. A scene with a road user (304 and 303) nearby and further away on a road 305 or roadway which leads past a house 306 is acquired. The camera sensor is in a position to acquire such an overall image with maximum width, height and resolution (or number of pixels). However, the processing of this large amount of data (e.g., in the region of 5 to 10 megapixels) is typically not possible in real time in an AD or ADAS system, which is why reduced image data are processed further.

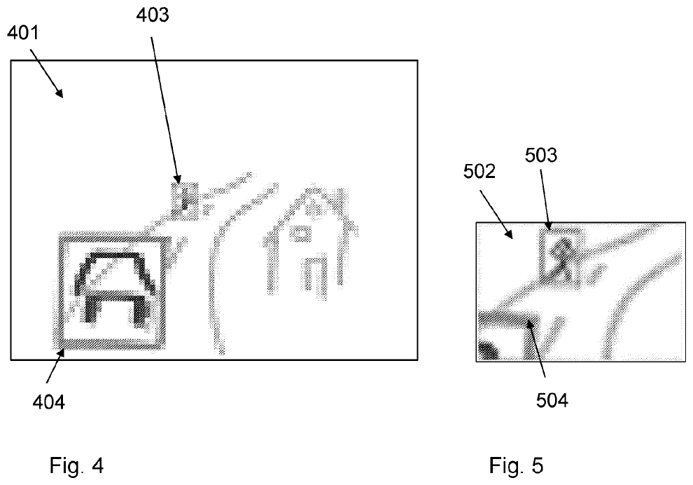

FIG. 4 schematically shows the reduced-resolution overall image or overview image 401. Half-resolution reduces the number of pixels by a factor of four. The reduced-resolution overall image 401 is referred to below as a wfov (wide field of view) image. The nearby road user 404 (the vehicle) can also be detected from the reduced-resolution wfov image. However, the distant road user 403 (the pedestrian) cannot be detected from this wfov image due to the limited resolution.

FIG. 5 schematically shows a high-resolution (or maximum-resolution) central image section 502. The high-resolution image section 502 is referred to below as the center image.

The center image makes it possible to detect the distant pedestrian 503 due to the high resolution. In contrast, the nearby vehicle 504 is not or almost not (i.e., only to a small extent) contained in the acquisition range of the center image 502.

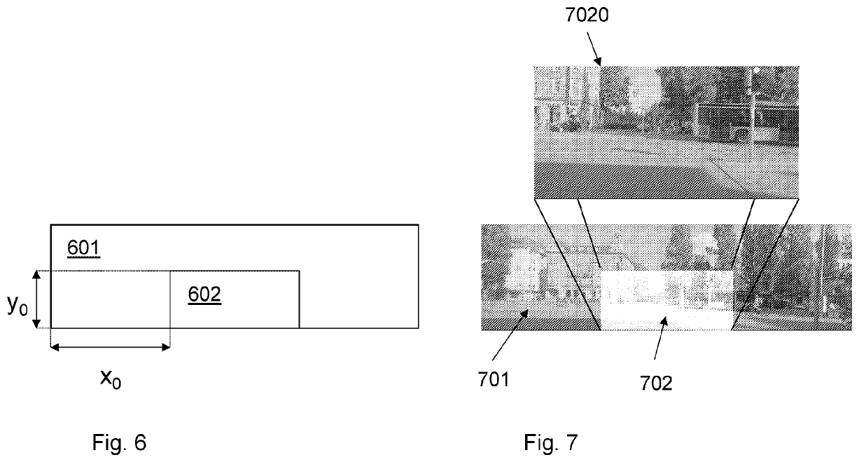

FIG. 6 shows an alternative arrangement of a first (overview) acquisition range 601 and a central acquisition range 602. This central acquisition range 602 is “at the bottom”, i.e., beginning vertically at the same height as the overall acquisition range 601. The position of the central acquisition range 602 in the horizontal and vertical directions within the overall or overview acquisition range can be indicated by starting values x₀, y₀.

FIG. 7 shows an example of how corresponding digital images could appear as a grayscale image. At the bottom, a wfov image 701 which a front camera of a vehicle has acquired can be seen as the first image. The vehicle is approaching an intersection. A large, possibly multi-lane road runs perpendicular to the direction of travel. A bicycle lane runs parallel to the large road. A traffic light regulates the right of way of the road users. Buildings and trees line the road and sidewalks. The central image section 702 is depicted, faded, in the wfov image 701 in order to illustrate that this image section, as a higher-resolution second image (center image) 702, corresponds exactly to this image section 702 of the first image 701. The second image 7020 is depicted at the top and, here, it is easier for the human viewer to recognize that the traffic light is displaying red for the ego-vehicle, that a bus has just crossed the intersection from left to right, and further details of the acquired scene. Due to the higher resolution in the second image 7020, objects or road users which are further away can also be robustly detected by image processing. The image pyramid could, e.g., have 2304×1280 pixels on the highest level for the second (center) image, 1152×640 pixels on the second level, 576×320 pixels on the third level, 288×160 pixels on the fourth level, 144×80 pixels on the fifth level, etc. Of course, the image pyramid for the first (wfov) image has more pixels at the same resolution (that is to say, on the same level based on the center image).

Since the wfov and the center image are typically derived from different pyramid levels, the center image is adjusted to the resolution of the wfov image using resolution-reducing operations. In the case of the feature map of the center image, the number of channels is typically increased (higher information content per pixel). Resolution-reducing operations are, e.g., striding or pooling. In the case of striding, only every second (or fourth or nth) pixel is read out. In the case of pooling, multiple pixels are combined into one, e.g., in the case of MaxPooling, the maximum value of a pixel pool (e.g., of two pixels or 2×2 pixels) is adopted.

Let us suppose that the level 5 overview image has 400×150 pixels and the level 5 center image lies x₀=133 pixels in the horizontal direction from the left edge of the overview image and extends y₀=80 pixels in the vertical direction from the bottom edge of the overview image. Let us suppose each pixel corresponds to an element in an output feature map. Then, in order to adapt the second output feature map, 133 zeros per line (one for each pixel) would have to be added on the left, 70 zeros per column at the top and 133 pixels per line on the right as well, so that the channels of the adapted second output feature map can be added element-by-element. The starting values x₀, y₀ are determined from the position of the (second) image of the partial region within the (first) image of the overview area. They indicate the displacement or extension in the horizontal and vertical directions.

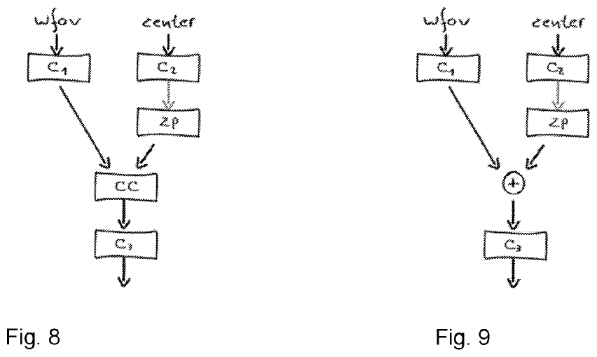

FIG. 8 schematically shows a way in which such images (e.g., the first or wfov image 701 and the second or center image 7020 from FIG. 7) can in principle be fused.

The wfov image is transferred as input image data to a first convolutional layer c1 of an artificial neural network (e.g., CNN).

The center image is transferred as input image data to a second convolutional layer c2 of the CNN. Each convolutional layer has an activation function and optional pooling.

The center image is padded using a ‘large’ zero padding ZP region such that the height and width match those of the wfov image, wherein the spatial relation is maintained. On the basis of FIG. 7, it can be imagined that the region 701 without the central image section 702 (i.e., the region from the wfov image 701 which is not depicted faded—that is to say depicted darker—at the bottom in FIG. 7) for the center image 7020 is padded with zeros. The higher resolution of the center image 7020 leads to a higher depth of the (second) feature map which the second convolutional layer c2 generates. The height and width of the second feature map correspond to the height and width of the central image section 702 of the wfov image 701. In this case, an adaptation of the different height and width of the first and second feature maps takes place through the zero padding ZP of the second feature map.

The features of the wfov image and center image are concatenated cc.

The concatenated features are transferred to a third convolutional layer c3 which generates the fused feature map.

Within the framework of the convolution having the second feature map (padded by means of zero padding ZP), many multiplications by zero are required. These calculations of ‘0’ multiplicands of the zero padding ZP region in the convolutional layer c3 are unnecessary and, consequently, not advantageous. However, it is not possible to suspend these regions since, e.g., known CNN accelerators do not allow spatial control of the application region of convolution kernels.

On the other hand, it is advantageous that the depth of the two feature maps can be different. The concatenation links both feature maps “together in depth”. This is particularly advantageous in the case that the center image has a higher resolution than the wfov image, which is why more information can be extracted from the center image. In this respect, this way is comparatively flexible.

FIG. 9 schematically shows an alternative second way: Wfov and center features are merged via appropriate element-by-element addition (+) (instead of concatenation cc of the two feature maps), wherein the height and width are, in turn, previously adjusted by means of zero padding ZP for the center image following feature extraction by the second convolutional layer c2. The feature map with the element-by-element added features is transferred to the third convolutional layer c3.

In the case of this way as well, a degradation in performance is accepted, since features having different semantic meanings are combined by the addition. In addition, it is not advantageous that the tensors must have the same dimension.

The advantage is that the addition of zeros (in the zero padding ZP range) requires significantly less computing time than the multiplications by zero.

Both of the ways described above each have advantages and

disadvantages. It would be desirable to exploit the respective advantages, which is possible in the case of a clever combination.

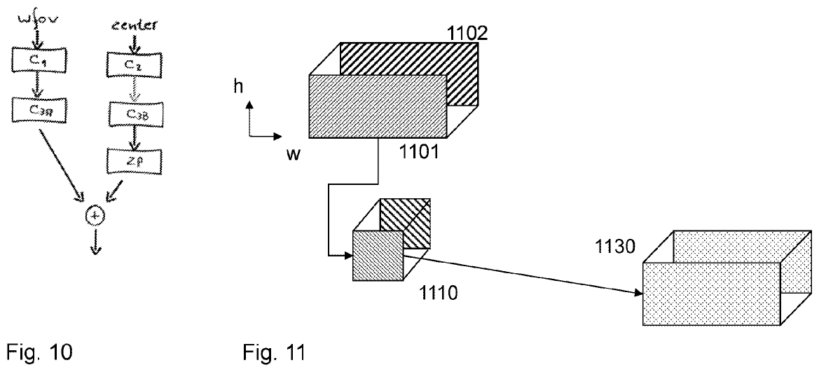

FIG. 10 schematically shows an advantageous way.

Starting from the first alternative which is depicted in FIG. 8, that is to say a merging of features by concatenation, a mathematical decomposition of c3 is described below, which makes the unnecessary multiplication of the zeros of the zero padding ZP region obsolete:
A convolutional layer Cₙ produces a 3-dimensional tensor FMₙ having Oₙ feature layers (channels), n is a natural number
The following applies to a conventional 2D convolution:

$${FM}_{n}^{i} = {\sum }_{i} {c}_{n}^{i , j} ( {FM}_{n - 1}^{i} )$$

wherein i, j are natural numbers.
The following applies to the convolutional layer c3 from FIG. 8:

$${FM}_{3}^{j} = {\sum }_{i} {c}_{3}^{i , j} ( cc ( {FM}_{1} , {FM}_{2} ) ) {FM}_{3}^{j} = {\sum }_{i = 0}^{{o}_{1} - 1} {c}_{3}^{i , j} ( {FM}_{1}^{i} ) + {\sum }_{i = 0}^{{o}_{2} - 1} {c}_{3}^{i + {0}_{1} j} ( {FM}_{2}^{i} )$$

since the convolution is linear for concatenated input data.

A concatenation with a subsequent convolutional layer (cf. FIG. 8) is converted into two reduced convolutions C_{3A} and C_{3B} with subsequent element-by-element addition (+):

$${c}_{3 A}^{i , j} = {c}_{3}^{i , j} , ∀ i < {o}_{1} , j$$

$${c}_{3 B}^{i , j} = {c}_{3}^{i + {o}_{1} , j} , ∀ i < {o}_{2} , j .$$

The different height and width of the feature maps generated from the two reduced convolutions C_{3A} and C_{3B} are adjusted prior to the element-by-element addition (+).

By splitting the convolution kernel C₃ into C_{3A} and C_{3B}, the convolution C_{3B} is applied in a runtime-efficient manner to the reduced size of the center image. This element-by-element addition (+) is runtime-neutral in the case of those accelerators which can currently be deployed for artificial neural networks.

A zero padding ZP with subsequent addition is equivalent to summing up the center features at an adjusted starting position. Alternatively, the center feature map can be written to a larger region which has previously been initialized by zero. The zero padding ZP then takes place implicitly.

An activation function/a pooling following c3 cannot be split and is applied following the addition.

In particular, no convolution operations are calculated over large padding areas which consist of zeros.

Overall, this embodiment offers the following as particular advantages:
a) an integrated feature viewing of different (image) pyramid levels for optimum overall performance with a large viewing angle/acquisition region of the image acquisition sensor, exploiting high-resolution ROIs, e.g., for distant objects;
b) with simultaneous runtime-efficient implementation.

The procedure is once again illustrated in different ways in FIGS. 11 to 13.

FIG. 11 schematically shows a concatenation of two feature maps 1101, 1102 which are processed by a convolution kernel 1110, resulting in a fused feature map 1130 which can be output. In contrast to the similar situation in FIG. 8, both feature maps 1101, 1102 have an identical width w and height h. Both are depicted in simplified form as two rectangular areas. Concatenation denotes hanging behind one another in depth and is depicted schematically such that the second feature map 1102 is spatially arranged behind the first feature map 1101.

The convolution kernel 1110 is depicted here in a comparable manner with opposite hatching, which is intended to illustrate that a first part, i.e., a “first convolution 2d kernel” which is depicted with thin hatching scans the first feature map 1101 and a second (depicted with thick hatching) convolution 2d kernel scans the second feature map 1102.

The result is a fused output feature map 1130. The fused feature map 1130 can no longer be separated in terms of the first and second feature map 1101, 1102 as a consequence of the convolution.

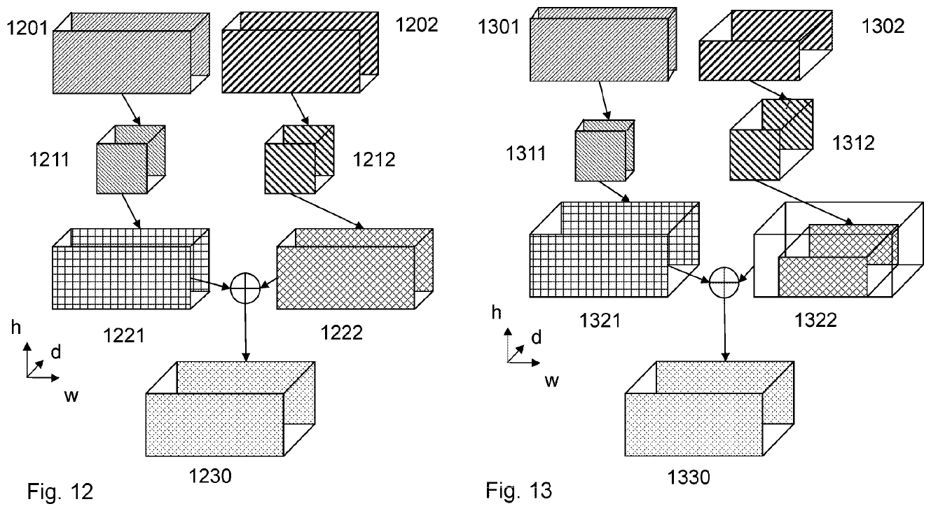

FIG. 12 schematically shows an alternative process for fusing two feature maps of identical width w, height h and depth d. The depth d of a feature map can correspond to the number of channels or depend on the resolution of the underlying image.

In the present case, the first feature map 1201 is scanned by a first convolution 2d kernel 1211, resulting in the first output feature map 1221, and the second feature map 1202 is scanned by a second convolution 2d kernel 1212, resulting in the second output feature map 1222. A convolution 2d kernel 1211; 1212 can, for example, have a dimension of 3×3×“number of input channels” and generates an output layer. The depth of the output feature maps can be defined by the number of convolution 2d kernels 1211; 1212.

The fused feature map 1230 can be calculated from the two output feature maps 1221, 1222 through element-by-element addition (+).

The process here, that is to say performing two separate convolutions for each feature map and subsequently simply adding these, is equivalent to the process according to FIG. 11, where the two feature maps are concatenated and subsequently a convolution is performed.

FIG. 13 schematically shows the process for fusing two feature maps of different width and height—corresponding to the process depicted in FIG. 10.

The first feature map 1301 (calculated from the wfov image) has a larger width w and height h; on the other hand, the depth d is smaller, whereas the second feature map 1302 (calculated from the high-resolution center image section) has a smaller width w and height, but a greater depth d.

A first convolution 2d kernel 1311 scans the first feature map 1301, resulting in a first output feature map 1321 with an increased depth d. The second feature map is scanned by a second convolution 2d kernel 1312, resulting in the second output feature map 1322 (diagonally hatched cuboid area). The depth d of the second output feature map is identical to the depth of the first output feature map.

In order to perform a fusion of the first and second output feature maps 1321, 1322, it is expedient that the position of the partial region within the overview region be taken into consideration. Accordingly, the height and width of the second output feature map 1322 are enlarged such that they correspond to the height and width of the first output feature map 1321. Starting values in width and height for the adaptation can be determined, for example, from FIG. 6 or 7 by indicating the position of the central region 602 or 702 in the entire overview region 601 or 701, e.g., in the form of starting values x₀, y₀ or width and height starting values xₛ, yₛ of the feature map, which are derived therefrom.

The regions missing in the case of the second output feature map 1322 (left, right and top) are padded with zeros (zero padding). The consequently adapted second output feature map can now be fused with the first output feature map 1321 simply through element-by-element addition. The feature map 1330 fused in this way is depicted at the bottom in FIG. 13.

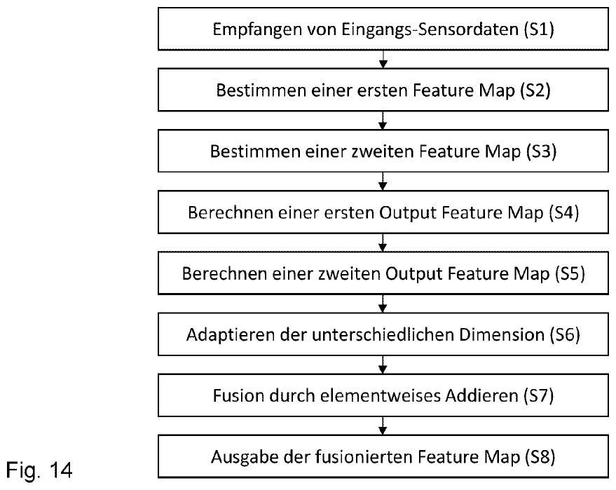

FIG. 14 schematically shows a possible course of the method.

In a first step S1, input data from at least one image acquisition sensor are received. The input sensor data can have been generated, for example, by two ADAS sensors of a vehicle looking in the direction of travel, e.g., of a telecamera and a lidar having a partially overlapping acquisition range. The lidar sensor could have a wide acquisition range (e.g., aperture angle greater than 100° or 120°), resulting in a first image or a first representation of the scene. The telecamera only acquires a (central) partial region of the scene (e.g., acquisition angle less than 50°), but can detect objects which are further away, resulting in a second representation of the scene. In order to be able to fuse the input data from the lidar and telecamera sensors, raw sensor data can be mapped onto images which reproduce a bird's-eye view of the road ahead of the vehicle.

Lidar and telecamera data exist in the region of overlap, only lidar data exist in the lateral edge areas, and only telecamera data exist in the far-off front area.

In the second step S2, a first feature map is determined from the input data. From the (first) image of the lidar sensor, the first feature map can be produced with a first height and width (or roadway depth and width in the bird's-eye view).

In the third step S3, a second feature map is determined from the input data. A second feature map with a second height and width can be produced from the (second) image of the acquisition region of the telecamera. In this case, the width of the second feature map is less than that of the first feature map and the height (distance in the direction of travel) of the second feature map is greater than that of the first feature map.

In the fourth step S4, a first output feature map is determined on the basis of the first feature map. The first output feature map is calculated by means of a first convolution of the first feature map.

In the fifth step S5, a second output feature map is determined on the basis of the second feature map. The second output feature map is calculated by means of a second convolution of the second feature map. The second convolution is limited in height and width to the height and width of the second feature map.

In a sixth step S6, the different dimensions of the first and second output feature maps are adapted, in particular the height and/or width are adapted.

To this end, according to a first variant, the height of the first output feature map can be enlarged such that it corresponds to the height of the second output feature map. The width of the second output feature map is enlarged such that it corresponds to the width of the first output feature map. The newly added regions of the respective (adapted) output feature map due to the enlargement are padded with zeros (zero padding).

In accordance with a second variant, a template output feature map is initially created, the width and height of which result from the height and width of the first and second output feature maps and the position of the region of overlap. The template output feature map is padded with zeros. In the present case, the template output feature map has the width of the first output feature map and the height of the second output feature map.

For the adapted first output feature map, the elements from the first output feature map are adopted in the region covered by the first output feature map. To this end, starting values can be used, which indicate the position of the first output feature map in the vertical and horizontal directions within the template output feature map. The lidar output feature map extends, e.g., over the entire width of the template output feature map, but a region of large distances is blank. That is to say that, in the vertical direction, a starting value yₛ can be specified, as of which the template output feature map is “padded”.

In the same way, starting from the template output feature map pre-padded with zeros, the adapted second output feature map is generated: by inserting the elements of the second output feature map as of the suitable starting position. For example, the radar output feature map is only transmitted as of a horizontal starting position xₛ and extends over the entire height in the vertical direction.

In the seventh step S7, the adapted first and second output feature maps are fused through element-by-element addition. Due to the adaptation of the height and width, the element-by-element addition of the two output feature maps is immediately possible for typical CNN accelerators. The result is the fused feature map.

In the special case that the second output feature map contains the entire region of overlap (that is to say, a genuine partial region of the first output feature map which includes an overview region—cf. FIG. 13), an adaptation of the different height and width of the second output feature map can be dispensed with, in that the second output feature map is added element-by-element to the first output feature map by means of suitable starting values xₛ, yₛ only in the region of overlap. The height and width of the fused feature map are then identical to the height and width of the first output feature map (cf. FIG. 13).

The fused feature map is output in the eighth step S8.

### LIST OF REFERENCE NUMERALS

1 Image acquisition sensor
10 System
12 Input interface
14 Data processing unit
16 Fusion module
18 Output interface
20 Control unit
101 Overview region
102 Partial region
300 High-resolution overview image
303 Pedestrian or road user further away
304 Vehicle or road user nearby
305 Road or roadway
306 House
401 Reduced-resolution overview image
403 Pedestrian (cannot be detected)
404 Vehicle
502 High-resolution central image section
503 Pedestrian
504 Vehicle (cannot be detected or cannot be detected completely)
601 Overview region
602 Partial region
701 Reduced-resolution overview image
702 Acquisition range for high-resolution image section
7020 High-resolution (central) image section
1101 First feature map
1102 Second feature map
1110 Convolution kernel
1130 Fused feature map
1201 First feature map
1202 Second feature map
1211 First convolution 2d kernel
1212 Second convolution 2d kernel
1221 First output feature map
1222 Second output feature map
1230 Fused feature map
1301 First feature map
1302 Second feature map
1311 First convolution 2d kernel
1312 Second convolution 2d kernel
1321 First output feature map
1322 Second output feature map
1330 Fused feature map
x₀ Starting value in the horizontal direction
y₀ Starting value or extension value in the vertical direction
wfov Reduced-resolution overview image center High-resolution (central) image section
cₖ Convolutional layer k; k∈N (with activation function and optional pooling)
ZP Zero padding
CC Concatenation
⊕ Element-by-element addition
W Width
h Height
d Depth

1. A method for fusing image data from at least one image acquisition sensor having the following steps:
a) receiving input image data, wherein the input image data comprise:
a first image which comprises a first region of a scene, and
a second image which comprises a second region of the scene, wherein the first and second regions overlap one another, but are not identical-;
b) determining a first feature map with a first height and width on the basis of the first image and determining a second feature map with a second height and width on the basis of the second image;
c) computing a first output feature map by a first convolution of the first feature map, and computing a second output feature map by a second convolution of the second feature map;
d) computing a fused feature map through element-by-element addition of the first and second output feature maps, wherein computing the fused feature map is based on positions of the first and the second regions with respect to one another, such that the elements in the region of overlap are added; and
e) outputting the fused feature map.

2. The method according to claim 1, further comprising acquiring the first and the second image by the same image acquisition sensor.

3. The method according to claim 1, wherein the first and second images correspond to different levels of one or more image pyramids of an original image acquired by the at least one image acquisition sensor.

4. The method according to claim 1, wherein the first region is an overview region of the scene and the second region is a partial region of the overview region of the scene.

5. The method according to claim 1, wherein the first image has a first resolution and the second image has a second resolution, wherein the second resolution is higher than the first resolution.

6. The method according to claim 1, wherein two monocular cameras having an overlapping acquisition range are deployed as the at least one image acquisition sensor.

7. The method according to claim 1, wherein multiple cameras of a panoramic-view camera system are deployed as the at least one image acquisition sensor.

8. The method according to claim 1, wherein the first and second output feature maps have the same height and width in the region of overlap.

9. The method according to claim 1, wherein the height and width of the fused feature map are determined by a rectangle which surrounds the first and the second output feature maps.

10. The method according to claim 1, wherein the feature maps each have a depth which depends on a resolution of at least one of the first image or the second image.

11. The method according to claim 1, wherein the fused feature map is generated in an encoder of an artificial neural network which is configured to determine ADAS/AD-relevant information.

12. The method according to claim 11, wherein the artificial neural network which is configured to determine ADAS/AD-relevant information comprises multiple decoders for different ADAS/AD detection functions.

13. A system for fusing image data from at least one image acquisition sensor, comprising an input interface, a data processing unit and an output interface, wherein
a) the input interface is configured to receive input image data, wherein the input image data comprise:
a first image which comprises a first region of a scene, and
a second image which comprises a second region of the scene, wherein the first and second regions overlap one another but are not identical;
b) the data processing unit is configured to:
determine a first feature map with a first height and width on the basis of the first image and determine a second feature map with a second height and width on the basis of the second image;
compute a first output feature map by means of a first convolution of the first feature map, and compute a second output feature map by a second convolution of the second feature map;
and
compute a fused feature map through element-by-element addition of the first and second output feature maps, wherein the fused feature map is based on positions of the first and the second regions with respect to one another, such that the elements in region of overlap are added; and
c) the output interface is configured to output the fused feature map.

14. The system according to claim 13, wherein the system comprises a convolutional neural network having an encoder and at least one decoder and wherein the input interface, the data processing unit and the output interface are implemented in the encoder such that the encoder is configured to generate the fused feature map and wherein the at least one decoder is configured to realize an ADAS/AD detection function at least on the basis of the fused feature map.

15. A vehicle having at least one image acquisition sensor and a system according to claim 13.
